(19) United States
(12) Patent Application Publication
(10) Pub. No.: US 2021/0245236 A1
(43) Pub. Date: Aug. 12, 2021

(54) Multi-Functional Riveting Tool

(71) Applicant: Karat Industrial Corporation, New Taipei City (TW)

(72) Inventor: Philey Ko, New Taipei City (TW)

(21) Appl. No.: 17/130,010

(22) Filed: Dec. 22, 2020

(30) Foreign Application Priority Data
Feb. 11, 2020 (TW) 109104171

(51) Int. Cl. B21J 15/38

(52) U.S. Cl. CPC B21J 15/383

(57) ABSTRACT

A multi-functional riveting tool has a holding handle, an operating handle pivotally connected with the holding handle, a torsion spring having two ends respectively abutting against the holding handle and the operating handle, a sleeve assembly mounted in a top portion of the holding handle, and a connecting driving assembly including a pulling shaft and a snapping set alternatively mounted in the sleeve assembly. With a structure and an internal space for mounting the pulling shaft and the snapping set formed in the sleeve assembly, a user is able to install the pulling shaft for connecting with a rivet nut, the pulling shaft for connecting with a rivet bolt or the snapping set for mounting a blind rivet in the sleeve assembly for different use. Only one riveting tool should be prepared. Accordingly, the riveting tool of the present invention is practical for use.

### CROSS-REFERENCE TO RELATED APPLICATIONS

This application is based upon and claims priority under 35 U.S.C. 119 from Taiwan Patent Application No. 109104171 filed on Feb. 11, 2020, which is hereby specifically incorporated herein by this reference thereto.

### BACKGROUND OF THE INVENTION

### 1. Field of the Invention

The present invention relates to a riveting tool, especially to a multi-functional riveting tool that can be used for fastening a rivet nut, a rivet bolt or a blind rivet by replacing internal parts.

### 2. Description of the Prior Art(s)

A riveting tool is for fastening a rivet, such as a rivet nut, a rivet bolt or a blind rivet, to the workpiece(s). The rivet nut can form internal threads in the workpiece, the rivet bolt can form external threads on the workpiece, and the blind rivet can fasten at least two workpieces together.

With reference to FIG. 10, a conventional riveting tool, as disclosed in US Patent “POSITIONING ASSEMBLY OF A HAND RIVET NUT TOOL” with U.S. Pat. No. 8,468,668, comprises a sleeve assembly 70 mounted in a top portion 611 of a tool body 61. The sleeve assembly 70 includes an inner sleeve and rotating sleeve 72. The inner sleeve 71 can be driven by an operating handle 62 to move back and forth in an axial direction. The rotating sleeve 72 is mounted in the inner sleeve 71 and is coaxial with the inner sleeve 71. Moreover, the rotating sleeve 72 is connected with the inner sleeve 71 via screw threads. Thus, when the rotating sleeve 72 is rotated, the rotating sleeve 72 moves relative to the inner sleeve 71 along the axial direction.

A pulling shaft 73 for securely connecting with a rivet nut or a rivet bolt is mounted through the inner sleeve 71 and the rotating sleeve 72 and is detachably held at a specific position in the rotating sleeve 72 by a positioning ring 74. By rotating the rotating sleeve 72 to adjust a length of a rear end portion of the rotating sleeve 72 that protrudes out from a rear end of the tool body 61, a length of a front end portion of the pulling shaft 73 that protrudes out from a front end of the top portion 611 of the tool body 61 can be adjusted, so as to allow the rivet nut or the rivet bolt attached with the front end of the pulling shaft 73 to firmly abut against the front end of the top portion 611 of the tool body 61.

In the above-mentioned conventional riveting tool, although the pulling shaft 73 can be replaced with a suitable one for connecting with the rivet nut or the rivet bolt, the conventional riveting tool is unable to be used for applying a blind rivet to workpieces only by replacing some internal parts of the conventional riveting tool. Therefore, to a frequent user of the riveting tools, in addition to the conventional riveting tool for fastening the rivet nuts and the rivet bolts, an additional riveting tool for fastening the blind rivets is also needed. Reserving two sets of the riveting tools not only costs money, a double large room for storing the two sets of the riveting tools is also needed.

To overcome the shortcomings, the present invention provides a multi-functional riveting tool to mitigate or obviate the aforementioned problems.

### SUMMARY OF THE INVENTION

The main objective of the present invention is to provide a multi-functional riveting tool that has a holding handle, an operating handle, a torsion spring, a sleeve assembly and a connecting driving assembly. The operating handle is pivotally connected to the holding handle via a pivot pin. The torsion spring is mounted in the holding handle and has two ends abutting against the holding handle and the operating handle respectively. The sleeve assembly includes a front sleeve and a rear sleeve coaxially mounted in a top portion of the holding handle. The connecting driving assembly includes a pulling shaft and a snapping set alternatively mounted in the sleeve assembly.

With a structure and an internal space for mounting the pulling shaft and the snapping set formed in the sleeve assembly, a user is able to install the pulling shaft for connecting with a rivet nut, the pulling shaft for connecting with a rivet bolt or the snapping set for mounting a blind rivet in the sleeve assembly for different use. Only one riveting tool should be prepared. Accordingly, the riveting tool of the present invention is practical for use.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a multi-functional riveting tool in accordance with the present invention;

FIG. 2 is an enlarged exploded perspective view of the first embodiment of the multi-functional riveting tool in FIG. 1;

FIG. 3 is an enlarged side view in partial sectional of the first embodiment of the multi-functional riveting tool in FIG. 1;

FIG. 4 is an operational enlarged side view in partial sectional of the first embodiment of the multi-functional riveting tool in FIG. 1, showing a rivet nut being driven by the multi-functional riveting tool;

FIG. 5 is another operational enlarged side view in partial sectional of the first embodiment of the multi-functional riveting tool in FIG. 1, showing a jack nut being driven by the multi-functional riveting tool;

FIG. 6 is an enlarged exploded perspective view of a second embodiment of a multi-functional riveting tool in accordance with the present invention;

FIG. 7 is an operational enlarged side view in partial sectional of the second embodiment of the multi-functional riveting tool in FIG. 6, showing a rivet bolt being driven by the multi-functional riveting tool;

FIG. 8 is an enlarged exploded perspective view of a third embodiment of a multi-functional riveting tool in accordance with the present invention;

FIG. 9 is an operational enlarged side view in partial sectional of the third embodiment of the multi-functional riveting tool in FIG. 8, showing a blind rivet being driven by the multi-functional riveting tool; and

FIG. 10 is an enlarged side view in partial section of a conventional riveting tool in accordance with the prior art.

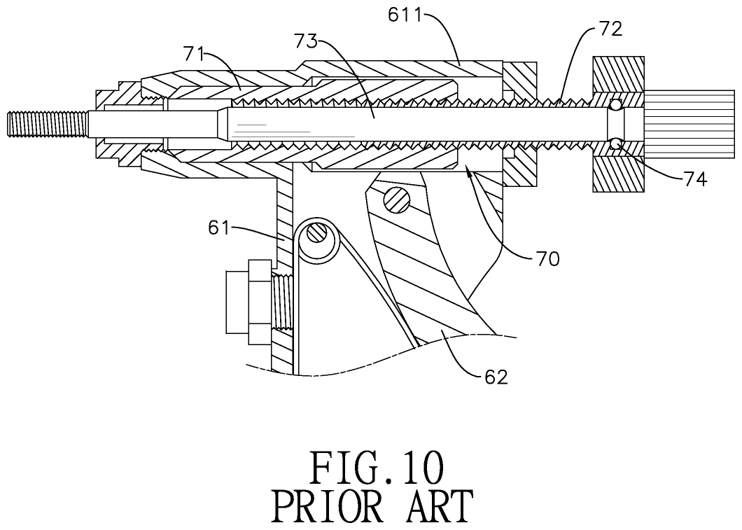

### DETAILED DESCRIPTION OF THE PREFERRED EMBODIMENTS

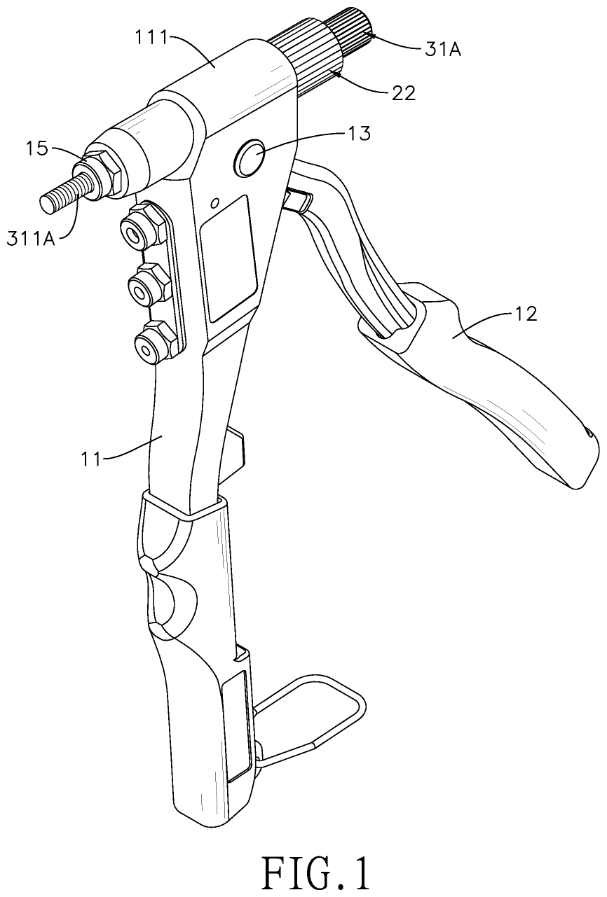

With reference to FIGS. 1 to 3, 6 and 8, a multi-functional riveting tool in accordance with the present invention comprises a holding handle 11, an operating handle 12, a torsion spring 14, a nosepiece 15, a sleeve assembly 20 and a connecting driving assembly 30.

The holding handle 11 has a top portion 111. The top portion 111 has a front end and a rear end oppositely defined on the top portion 111. The operating handle 12 is pivotally connected to the holding handle 11 via a pivot pin 13. The torsion spring 14 is mounted in the holding handle 11 and has two ends abutting against the holding handle 11 and the operating handle 12 respectively. The nosepiece 15 is mounted on the front end of the top portion 111 of the holding handle 11 and is connected with the top portion 111 of the holding handle 11 via screw threads.

The sleeve assembly 20 is mounted in the top portion 111 of the holding handle 11 and includes a front sleeve 21, a rear sleeve 22 and a positioning ring 23.

The front sleeve 21 is mounted in the top portion 111 of the holding handle 11 and is movable back and forth in an axial direction between the front end of the top portion 111 and the rear end of the top portion 111. The front sleeve 21 has a front end and a rear end oppositely defined on the front sleeve 21, and the front sleeve 21 further has a front through hole 211 and a connecting portion 213. The front end of the front sleeve 21 is positioned toward the front end of the top portion 111 of the holding handle 11 and the rear end of the front sleeve 21 is positioned toward the rear end of the top portion 111 of the holding handle 11. The front through hole 211 is formed in the front sleeve 21 and extends between and through the front end of the front sleeve 21 and the rear end of the front sleeve 21. A cone-shaped space 212 is defined in the front through hole 211 and corresponds in position toward the front end of the front sleeve 21. The cone-shaped space 212 is tapered off toward the front end of the front sleeve 21. The connecting portion 213 of the front sleeve 21 is formed on the rear end of the front sleeve 21.

The rear sleeve 22 is mounted in the rear end of the top portion 111 of the holding handle 11 and is detachably connected with the front sleeve 21. The rear sleeve 22 has a front end and a rear end oppositely defined on the rear sleeve 22, and the rear sleeve 22 has a rear through hole 221, an annular groove 222, a connecting portion 223 and an abutting protrusion 224. The rear through hole 221 is formed in the rear sleeve 22, extends between and through the front end of the rear sleeve 22 and the rear end of the rear sleeve 22, and is coaxial with the front through hole 211. The annular groove 222 is formed in and around an inner side surface of the rear sleeve 22. The connecting portion 223 of the rear sleeve 22 is formed on the front end of the rear sleeve 22 and is detachably connected with the connecting portion 213 of the front sleeve 21. The abutting protrusion 224 is formed on and radially protrudes from an outer side surface of the rear sleeve 22, and abuts against the rear end of the top portion 111 of the holding handle 11.

The positioning ring 23 is resilient and is mounted in the annular groove 222 of the rear sleeve 22. An inner annular edge of the positioning ring 23 protrudes beyond the inner side surface of the rear sleeve 22.

In the preferred embodiment of the present invention, the connecting portion 213 of the front sleeve 21 is an internal thread and the connecting portion 223 of the rear sleeve 22 is an external thread. With the internal thread engaging with the external thread, the front sleeve 21 and the rear sleeve 22 are detachably connected to each other.

An upper end of the operating handle 12 extends toward the top portion 111 of the holding handle 11 and is pivotally connected with the front sleeve 21. When the operating handle 12 is pushed, the operating handle 12 pivots on the pivot pin 13, the torsion spring 14 is deformed and the upper end of the operating handle 12 drives the front sleeve 21 and the rear sleeve 22 to move toward the rear end of the top portion 111 of the holding handle 11. When the operating handle 12 is released, a resilient restoring force of the torsion spring pushes the operating handle 12 to drive the front sleeve 21 and the rear sleeve 22 to move toward the front end of the top portion 111 of the holding handle 11.

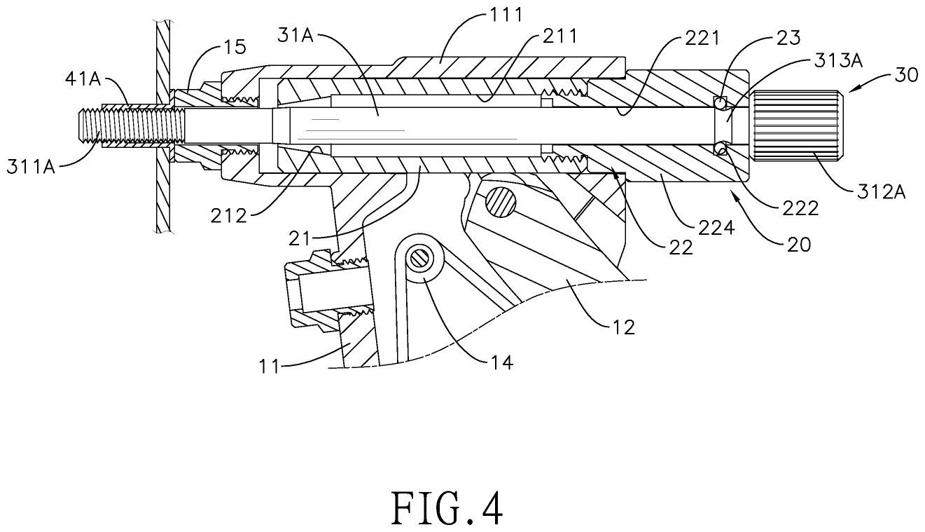

With further reference to FIGS. 4, 7, and 9, the connecting driving assembly 30 includes a pulling shaft 31A, 31B and a snapping set 32. The pulling shaft 31A, 31B and the snapping set 32 are alternatively mounted in the sleeve assembly 20.

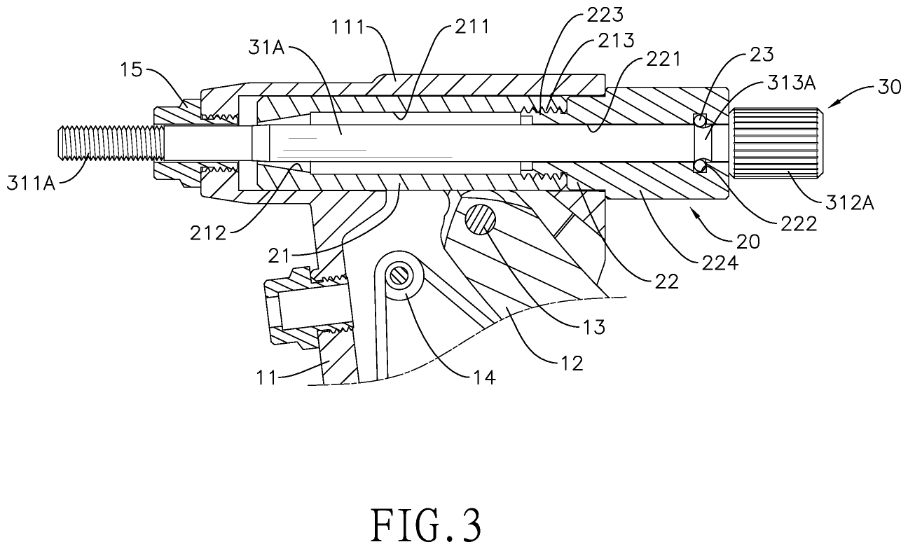

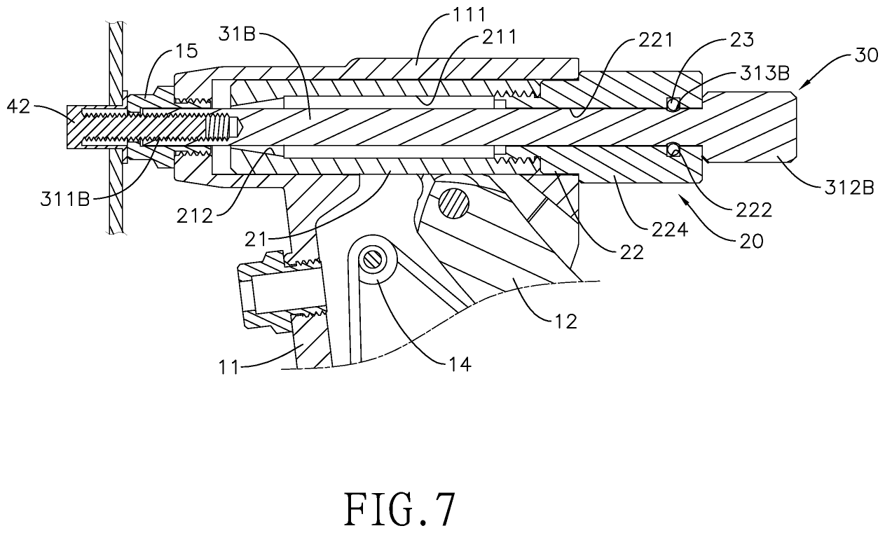

The pulling shaft 31A, 31B has a front end and a rear end oppositely defined on the pulling shaft 31A, 31B, and the pulling shaft 31A, 31B has a threaded portion 311A, 311B, a head 312A, 312B and a positioning groove 313A, 313B. The threaded portion 311A, 311B is formed on the front end of the pulling shaft 31A, 31B. The head 312A, 312B is formed on the rear end of the rear end of the pulling shaft 31A, 31B. The positioning groove 313A, 313B is formed in and around an outer side surface of the pulling shaft 31A, 31B. When the pulling shaft 31A, 31B is mounted in the sleeve assembly 20, the pulling shaft 31A, 31B extends through the front through hole 211 and the rear through hole 221, and the front end of the pulling shaft 31A, 31B protrudes out from the front end of the front sleeve 21. As shown in FIG. 3, the front end of the pulling shaft 31A may extend through the front end of the front sleeve 21 and protrude beyond the nosepiece 15. Or as shown in FIG. 7, the front end of the pulling shaft 31B may extend through the front end of the front sleeve 21 and being disposed inside the nosepiece 15. Moreover, the head 312A, 312B of the pulling shaft 31A, 31B abuts against the rear end of the rear sleeve 22, the inner annular edge of the positioning ring 23 securely engages in the positioning groove 313A, 313B of the pulling shaft 31A, 31B, such that the pulling shaft 31A, 31B is stably held in sleeve assembly 20 and does not move along the axial direction.

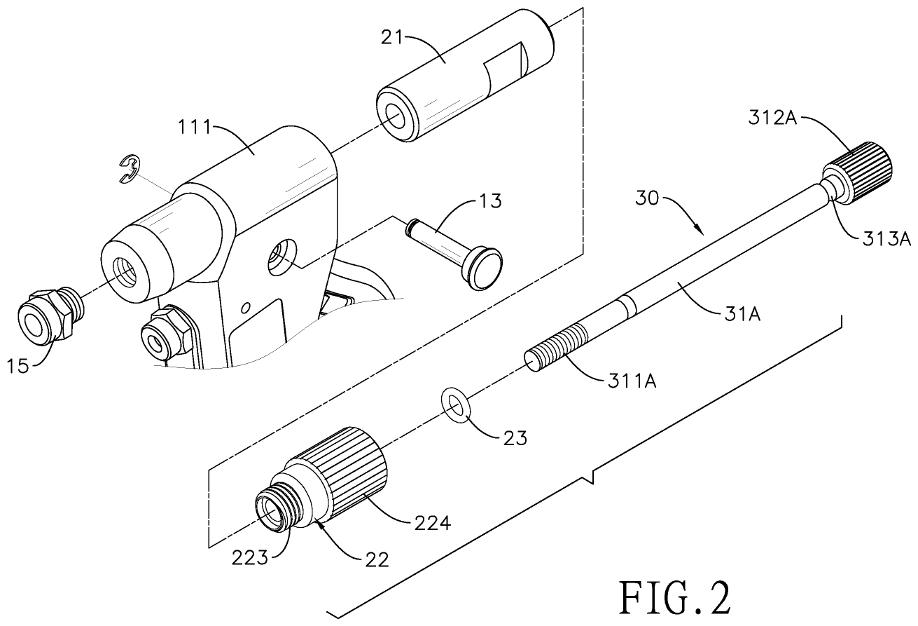

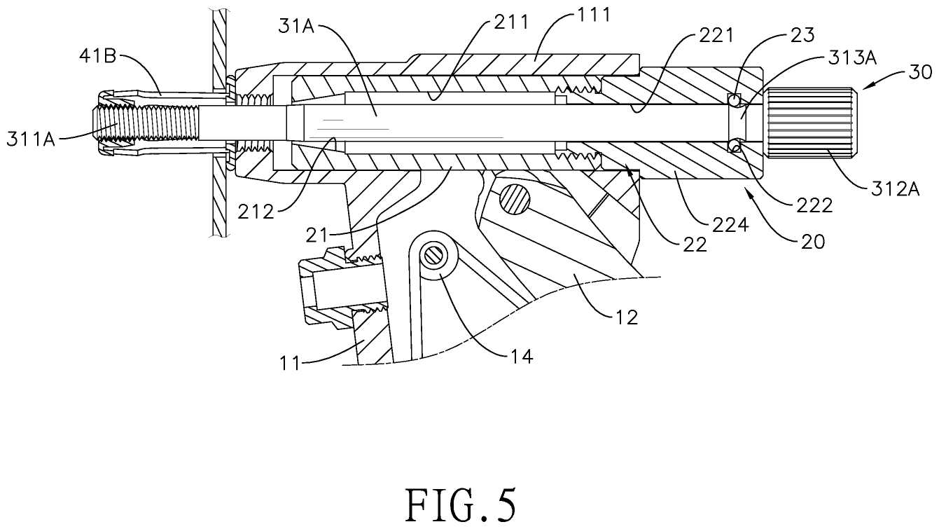

With reference to FIGS. 2 to 5, in the preferred embodiment of the present invention, the pulling shaft 31A may be for connecting with rivet nuts 41A, 41B. The threaded portion 311A of the pulling shaft 31A for connecting with the rivet nuts 41A, 41B is an external thread and protrudes out of the front end of the top portion 111 of the holding handle 11 or further protrudes out of the nosepiece 15. A plurality of the pulling shafts 31A having the external threads of different thread sizes may be prepared, so as to fit the rivet nuts 41A, 41B having internal threads of different thread sizes. As shown in FIG. 4, the rivet nut 41A attached onto the threaded portion 311A on the front end of the pulling shaft 31A that protrudes out of the nosepiece 15 may be a typical rivet nut. In addition, as shown in FIG. 5, the nosepiece 15 may be omitted. Thus, the threaded portion 311A on the front end of the pulling shaft 31A that protrudes out of the front end of the top portion 111 of the holding handle 11 may be attached with the rivet nut 41B that is generally name “Jack Nut”.

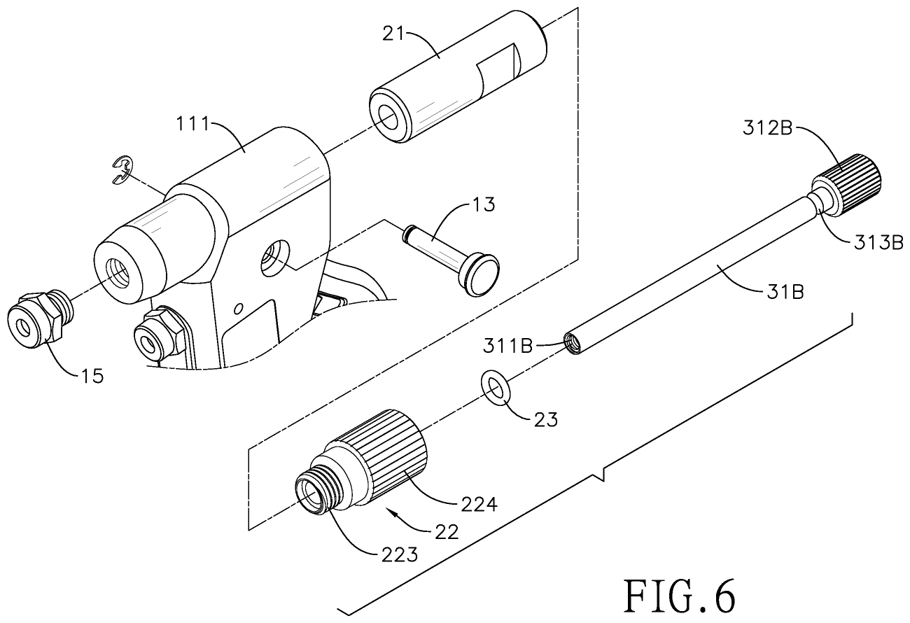

As shown in FIGS. 6 and 7, in the preferred embodiment of the present invention, the pulling shaft 31B may be for connecting with a rivet bolt 42. The threaded portion 311B of the pulling shaft 31B for connecting with the rivet bolt 42 is an internal thread. A plurality of the pulling shaft 31B having the internal threads of different thread sizes may be prepared, so as to fit the rivet bolts 42 having different external threads of different thread sizes.

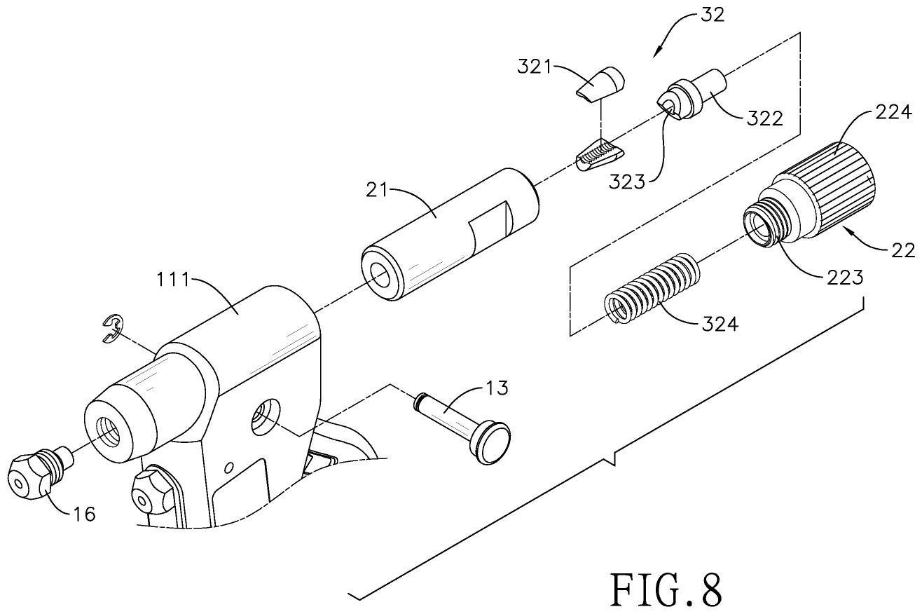

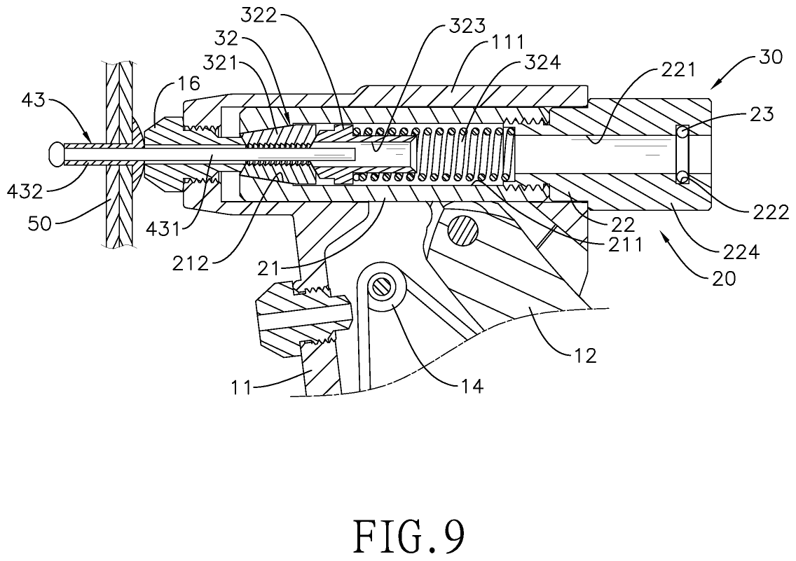

With reference to FIGS. 8 and 9, the snapping set 32 includes multiple jaws 321, a pushing slider 322 and a resilient element 324. The jaws 321 are arranged in a circle. The pushing slider 322 has a front end and a rear end oppositely defined on the pushing slider 322, and the pushing slider 322 further has a passing hole 323 extending between and through the front end of the pushing slider 322 and the rear end of the pushing slider 322. The resilient element 324 is disposed on the rear end of the pushing slider 322.

When the snapping set 32 is mounted in the sleeve assembly 20, the jaws 321 are mounted in the cone-shaped space 212 of the front through hole 211 of the front sleeve 21, and the pushing slider 322 is mounted in the front through hole 311 of the front sleeve 21 with the front end of the pushing slider positioned toward the jaws 321 and the rear end of the pushing slider 322 positioned toward the rear sleeve 22. Moreover, the resilient element 324 is mounted in the front through hole 211 of the front sleeve 21 and between the pushing slider 322 and the rear sleeve 22 with two opposite end of the resilient element 324 abutting against the pushing slider 322 and the rear sleeve 22 respectively. In a natural state, the resilient element 324 forces the pushing slider 322 to push and expand the jaws 321, and the jaws 321 abut against an inner side surface defined around the cone-shaped space 212 of the front sleeve 21.

When using the riveting tool mounted with the snapping set 32, a mandrel 431 of a blind rivet 43 is mounted into the top portion 111 of the holding handle 11 via the nosepiece 16 and is surrounded by the jaws 321. By pushing the operating handle 12 to drive the sleeve assembly 20 to move toward the rear end of the top portion 111 of the holding handle 11, the jaws 321 are shrunk and clamp the mandrel 431, a rivet cap 432 of the blind rivet 43 is deformed to be installed on at least two workpieces 50, and eventually, the cracked mandrel 431 is pulled off.

The multi-functional riveting tool as described has the following advantages. In the sleeve assembly 20, a structure and an internal space for mounting the pulling shaft 31A, 31B and the snapping set 32 is formed. Thus, a user of the riveting tool is able to install the pulling shaft 31A for connecting with the rivet nut 41A, 41B, the pulling shaft 31B for connecting with the rivet bolt 42 or the snapping set 32 for mounting the blind rivet 43 in the sleeve assembly 20 for different use. Only one riveting tool should be prepared. Accordingly, the riveting tool of the present invention is practical for use.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A multi-functional riveting tool comprising:
a holding handle having a top portion, and the top portion having a front end and a rear end;
an operating handle pivotally connected to the holding handle via a pivot pin;
a torsion spring mounted in the holding handle and having two ends abutting against the holding handle and the operating handle respectively;
a sleeve assembly mounted in the top portion of the holding handle and including
a front sleeve mounted in the top portion of the holding handle and being movable back and forth between the front end of the top portion and the rear end of the top portion, and the front sleeve having
a front through hole formed in the front sleeve and extending between and through a front end of the front sleeve and a rear end of the front sleeve, wherein a cone-shaped space is defined in the front through hole, corresponds in position toward the front end of the front sleeve, and is tapered off toward the front end of the front sleeve; and
a connecting portion formed on the rear end of the front sleeve, wherein an upper end of the operating handle extends toward the top portion of the holding handle and is pivotally connected with the front sleeve; and
a rear sleeve mounted in the rear end of the top portion of the holding handle and detachably connected with the front sleeve, and the rear sleeve having
a rear through hole formed in the rear sleeve, extending between and through a front end of the rear sleeve and a rear end of the rear sleeve, and being coaxial with the front through hole;
a connecting portion formed on the front end of the rear sleeve and detachably connected with the connecting portion of the front sleeve; and
an abutting protrusion formed on and radially protruding from an outer side surface of the rear sleeve, and abutting against the rear end of the top portion of the holding handle; and
a connecting driving assembly including a pulling shaft, and the pulling shaft having
a threaded portion formed on a front end of the pulling shaft; and
a head formed on a rear end of the rear end of the pulling shaft, wherein when the pulling shaft is mounted in the sleeve assembly, the pulling shaft extends through the front through hole and the rear through hole, the front end of the pulling shaft protrudes out from the front end of the front sleeve and the head of the pulling shaft abuts against the rear end of the rear sleeve.

2. The multi-functional riveting tool as claimed in claim 1, wherein
the rear sleeve further has an annular groove, and the annular groove is formed in and around an inner side surface of the rear sleeve;
the sleeve assembly further includes a positioning ring, the positioning ring is resilient and is mounted in the annular groove of the rear sleeve, and an inner annular edge of the positioning ring protrudes beyond the inner side surface of the rear sleeve; and
the pulling shaft further has a positioning groove, and the positioning groove is formed in and around an outer side surface of the pulling shaft;
wherein when pulling shaft is mounted in the sleeve assembly, the inner annular edge of the positioning ring securely engages in the positioning groove of the pulling shaft.

3. The multi-functional riveting tool as claimed in claim 1, wherein the connecting portion of the front sleeve is an internal thread, and the connecting portion of the rear sleeve is an external thread.

4. The multi-functional riveting tool as claimed in claim 1, wherein the pulling shaft is for connecting with rivet nuts, and the threaded portion of the pulling shaft is an external thread.

5. The multi-functional riveting tool as claimed in claim 2, wherein the pulling shaft is for connecting with rivet nuts, and the threaded portion of the pulling shaft is an external thread.

6. The multi-functional riveting tool as claimed in claim 3, wherein the pulling shaft is for connecting with rivet nuts, and the threaded portion of the pulling shaft is an external thread.

7. The multi-functional riveting tool as claimed in claim 4, wherein
the multi-functional riveting tool further comprises a nosepiece, and the nosepiece is mounted on the front end of the top portion of the holding handle and is connected with the top portion of the holding handle via screw threads; and
the front end of the pulling shaft extends through the front end of the front sleeve and protrudes beyond the nosepiece.

8. The multi-functional riveting tool as claimed in claim 5, wherein
the multi-functional riveting tool further comprises a nosepiece, and the nosepiece is mounted on the front end of the top portion of the holding handle and is connected with the top portion of the holding handle via screw threads; and
the front end of the pulling shaft extends through the front end of the front sleeve and protrudes beyond the nosepiece.

9. The multi-functional riveting tool as claimed in claim 6, wherein
the multi-functional riveting tool further comprises a nosepiece, and the nosepiece is mounted on the front end of the top portion of the holding handle and is connected with the top portion of the holding handle via screw threads; and
the front end of the pulling shaft extends through the front end of the front sleeve and protrudes beyond the nosepiece.

10. The multi-functional riveting tool as claimed in claim 1, wherein
the multi-functional riveting tool further comprises a nosepiece, and the nosepiece is mounted on the front end of the top portion of the holding handle and is connected with the top portion of the holding handle via screw threads;
the pulling shaft is for connecting with rivet bolts, and the threaded portion of the pulling shaft is an internal thread; and
the front end of the pulling shaft extends through the front end of the front sleeve and is disposed inside the nosepiece.

11. The multi-functional riveting tool as claimed in claim 2, wherein
the multi-functional riveting tool further comprises a nosepiece, and the nosepiece is mounted on the front end of the top portion of the holding handle and is connected with the top portion of the holding handle via screw threads;
the pulling shaft is for connecting with rivet bolts, and the threaded portion of the pulling shaft is an internal thread; and
the front end of the pulling shaft extends through the front end of the front sleeve and is disposed inside the nosepiece.

12. The multi-functional riveting tool as claimed in claim 3, wherein
the multi-functional riveting tool further comprises a nosepiece, and the nosepiece is mounted on the front end of the top portion of the holding handle and is connected with the top portion of the holding handle via screw threads;
the pulling shaft is for connecting with rivet bolts, and the threaded portion of the pulling shaft is an internal thread; and
the front end of the pulling shaft extends through the front end of the front sleeve and is disposed inside the nosepiece.

13. A multi-functional riveting tool comprising:
a holding handle having a top portion, and the top portion having a front end and a rear end;
an operating handle pivotally connected to the holding handle via a pivot pin;
a torsion spring mounted in the holding handle and having two ends abutting against the holding handle and the operating handle respectively;
a nosepiece mounted on the front end of the top portion of the holding handle and connected with the top portion of the holding handle via screw threads;
a sleeve assembly mounted in the top portion of the holding handle and including
a front sleeve mounted in the top portion of the holding handle and being movable back and forth between the front end of the top portion and the rear end of the top portion, and the front sleeve having
a front through hole formed in the front sleeve and extending between and through a front end of the front sleeve and a rear end of the front sleeve, wherein a cone-shaped space is defined in the front through hole, corresponds in position toward the front end of the front sleeve, and is tapered off toward the front end of the front sleeve; and
a connecting portion formed on the rear end of the front sleeve, wherein an upper end of the operating handle extends toward the top portion of the holding handle and is pivotally connected with the front sleeve; and
a rear sleeve mounted in the rear end of the top portion of the holding handle and detachably connected with the front sleeve, and the rear sleeve having
a rear through hole formed in the rear sleeve, extending between and through a front end of the rear sleeve and a rear end of the rear sleeve, and being coaxial with the front through hole;
a connecting portion formed on the front end of the rear sleeve and detachably connected with the connecting portion of the front sleeve; and
an abutting protrusion formed on and radially protruding from an outer side surface of the rear sleeve, and abutting against the rear end of the top portion of the holding handle; and
a connecting driving assembly including a snapping set, and the snapping set including
multiple jaws arranged in a circle;
a pushing slider having a passing hole, and the passing hole extending between and through a front end of the pushing slider and a rear end of the pushing slider; and
a resilient element;
wherein when the snapping set is mounted in the sleeve assembly, the jaws are mounted in the cone-shaped space of the front through hole of the front sleeve, the pushing slider is mounted in the front through hole of the front sleeve, two opposite end of the resilient element abut against the pushing slider and the rear sleeve respectively, and the resilient element forces the pushing slider to push the jaws.

14. The multi-functional riveting tool as claimed in claim 13, wherein
the rear sleeve further has an annular groove, and the annular groove is formed in and around an inner side surface of the rear sleeve; and
the sleeve assembly further includes a positioning ring, the positioning ring is resilient and is mounted in the annular groove of the rear sleeve, and an inner annular edge of the positioning ring protrudes beyond the inner side surface of the rear sleeve.

15. The multi-functional riveting tool as claimed in claim 13, wherein the connecting portion of the front sleeve is an internal thread, and the connecting portion of the rear sleeve is an external thread.
